(19) United States
(12) Patent Application Publication
(10) Pub. No.: US 2015/0192270 A1
(43) Pub. Date: Jul. 9, 2015

(54) ILLUMINATION DEVICE AND PHOTOGRAPHIC DEVICE HAVING THE SAME

(71) Applicant: VIVOTEK INC., New Taipei (TW)

(72) Inventors: Wen-Yuan LI, New Taipei (TW); Li-Shan SHIH, New Taipei (TW); Yi-Chuan CHEN, New Taipei (TW); Chih-Hung CHANG, New Taipei (TW)

(21) Appl. No.: 14/587,809

(22) Filed: Dec. 31, 2014

(30) Foreign Application Priority Data
Jan. 3, 2014 (TW) 103100256

(51) Int. Cl. F21V 7/09; H04N 5/225; H04N 7/18; F21V 33/00

(52) U.S. Cl. CPC F21V 7/09; F21V 33/0052; H04N 5/2256; H04N 7/18; F21W 2131/40

(57) ABSTRACT

An illumination device includes a light source and a reflective cup. The light source is for emitting a first beam and a second beam. A light intensity of the first beam is greater than a light intensity of the second beam. The reflective cup has a plurality of reflecting curved surfaces and a through hole formed by the plurality of reflecting curved surfaces. Each reflecting curved surface has a first reflective section and a second reflective section. A slope of the first reflective section is different from a slope of the second reflective section. The first beam is reflected to an off-axis region by the first reflective section. The second beam is reflected to a paraxial region by the second reflective section, such that a light intensity in the off-axis region is greater than a light intensity in the paraxial region.

### CROSS-REFERENCE TO RELATED APPLICATIONS

This non-provisional application claims priority under 35 U.S.C. §119(a) on Patent Application No(s). 103100256 filed in Taiwan, R.O.C. on Jan. 3, 2014, the entire contents of which are hereby incorporated by reference.

### BACKGROUND

1. Technical Field

The disclosure relates to an illumination device. More particularly, the disclosure relates to an illumination device with a reflective cup, and a photographic device that has the same.

2. Background

Surveillance cameras are widely used in different kinds of locations, such as industry plants, dormitories, stores, apartments, entrances of buildings or communities, hallways and other remote locations. The surveillance camera is for monitoring and recording human behaviors or accidents so that it is favorable for maintaining social control, recognizing threats, and avoiding criminal activities.

A surveillance camera generally comprises an auxiliary light source (such as a visible light-emitting diode and an infrared light-emitting diode), for illuminating the places with insufficient lighting. However, the light intensity of the auxiliary light source is uneven. In other words, the light intensity of the auxiliary light source at the center is greater than the light intensity at the peripheral. Furthermore, the surveillance camera cannot capture images clearly when objects are located far from the center of the auxiliary light source. To solve the problem, a lens is usually assembled in front of the auxiliary light source, for homogenizing lights of the images by a photorefractive effect. Nevertheless, due to high cost of the lens, the surveillance is more expensive, which increases the total cost of the surveillance camera. Moreover, after operating for a long time, the lens may be yellowed and further caused the light decayed issue.

Additionally, the illumination range, shape and ratio of the lights emitted from the auxiliary light source do not correspond to the shape and ratio of the image plane of the photosensitive element of the surveillance camera, which causes the uneven exposure of the image.

To sum up, it is important to avoid the image exposure and the light intensity being uneven, as well as reducing the cost of the photographic device.

### SUMMARY

One aspect of the disclosure provides an illumination device which comprises a light source and a reflective cup. The light source has an optical axis and for emitting a first beam and a second beam. An included angle between the first beam and the optical axis is different from an included angle between the second beam and the optical axis. A light intensity of the first beam is greater than a light intensity of the second beam. The reflective cup has a plurality of reflecting curved surfaces and a through hole formed by the plurality of reflecting curved surfaces. The light source is located at the through hole. The light source is surrounded by the plurality of reflecting curved surfaces. Each reflecting curved surface has a first reflective section and a second reflective section. A slope of the first reflective section is different from a slope of the second reflective section. The first beam is reflected to an off-axis region which is farther away from the optical axis by the first reflective section. The second beam is reflected to a paraxial region which is closer to the optical axis of the light source by the second reflective section, such that a light intensity in the off-axis region is greater than a light intensity in the paraxial region.

In another aspect of the disclosure provides an illumination device which comprises a light source and a reflective cup. The light source has an optical axis and for emitting a first beam and a second beam. An included angle between the first beam and the optical axis is different from an included angle between the second beam and the optical axis. A light intensity of the first beam is greater than a light intensity of the second beam. The reflective cup has a plurality of reflecting curved surfaces and a through hole formed by the plurality of reflecting curved surfaces. The light source is located at the through hole. The light source is surrounded by the plurality of reflecting curved surfaces. Each reflecting curved surface has a first reflective section and a second reflective section. A slope of the first reflective section is different from a slope of the second reflective section. The first beam is reflected to an off-axis region which is farther away from the optical axis by the first reflective section. The second beam is also reflected to the off-axis region, such that a light intensity in the off-axis region is greater than a light intensity in a paraxial region which is closer to the optical axis of the light source.

In another aspect of the disclosure provides a photographic device which comprises the said illumination device and an image capturing device. The illumination device has an illuminated surface corresponding to the light source. The optical axis passes through the illuminated surface. The paraxial region and the off-axis region are formed on the illuminated surface.

### BRIEF DESCRIPTION OF THE DRAWINGS

The disclosure will become more fully understood from the detailed description given herein-below and the accompanying drawings which are given by way of illustration only and thus are not limitative of the disclosure, and wherein:

FIG. 1 is a cross-sectional view of a photographic device according to a first embodiment of the disclosure;

FIG. 2 is an intensity distribution diagram of a light source in FIG. 1;

FIG. 3 is a cross-sectional view of an illumination device in FIG. 1;

FIG. 4 is a partially enlarged view of the illumination device in FIG. 3;

FIG. 5 is a perspective view of a reflective cup in FIG. 3;

FIG. 6 is a cross-sectional view of the illumination device in FIG. 1 and an illuminated surface illuminated by the illumination device according to the first embodiment of the disclosure;

FIG. 7 is an intensity distribution diagram of the light source after being reflected by the light source in FIG. 1;

FIG. 8 is a cross-sectional view of an illumination device and an illuminated surface illuminated by the illumination device according to a second embodiment of the disclosure; and

FIG. 9 is a cross-sectional view of an illumination device and an illuminated surface illuminated by the illumination device according to a third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

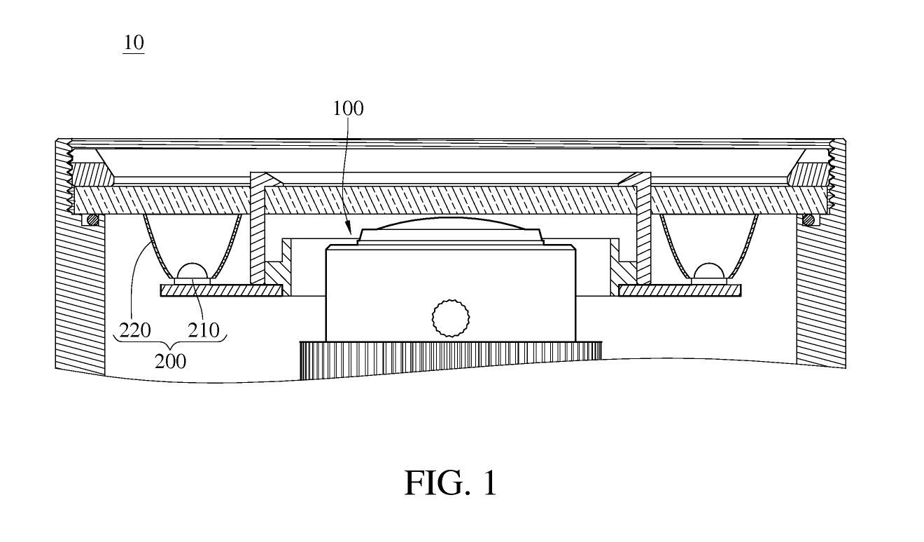

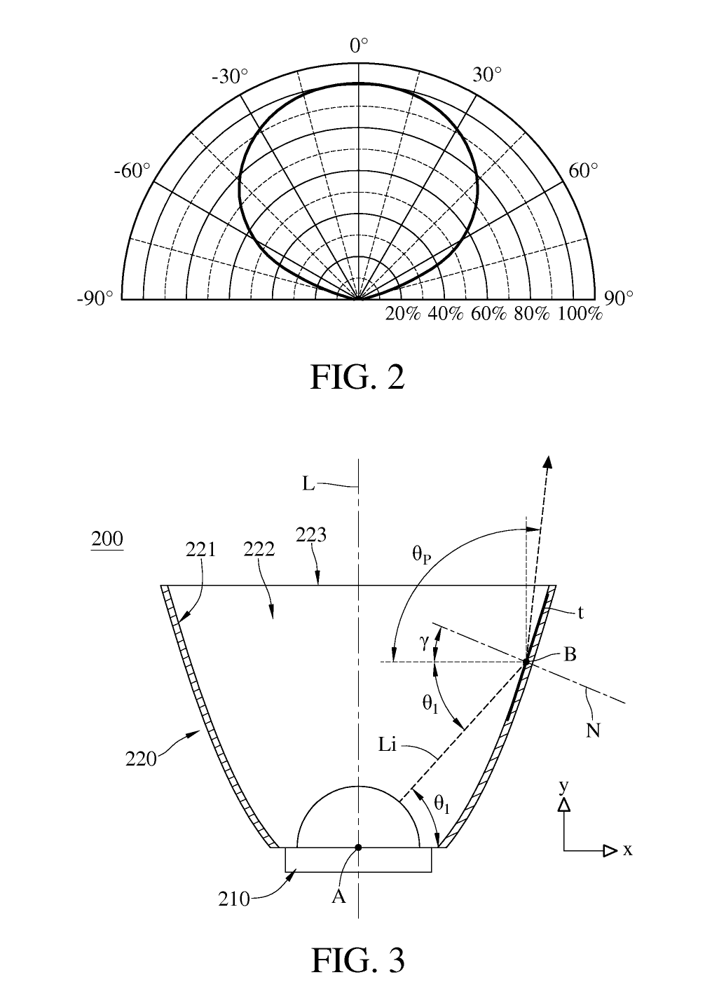

Please refer to FIG. 1 and FIG. 2. FIG. 1 is a cross-sectional view of a photographic device according to a first embodiment of the disclosure. FIG. 2 is an intensity distribution diagram of a light source in FIG. 1. In this embodiment, the photographic device 10 is a surveillance device. However, the photographic device 10 is not limited to the surveillance device. In other embodiments, for example, the photographic device 10 is a monocular camera. The photographic device 10 comprises an image capturing device 100 and at least one illumination device 200. The image capturing device 100, for example, is a photographic lens.

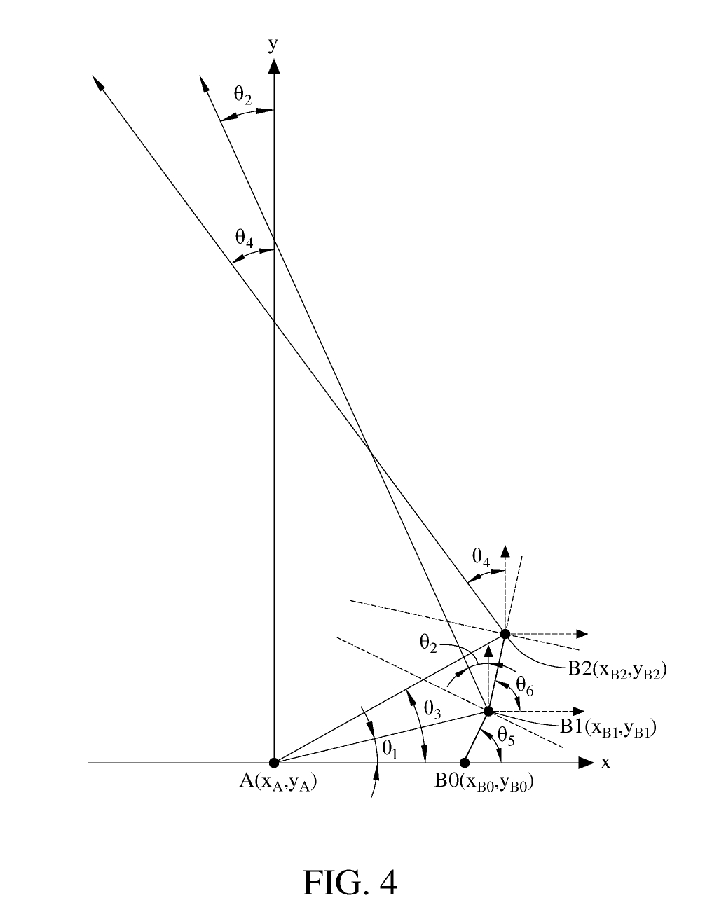

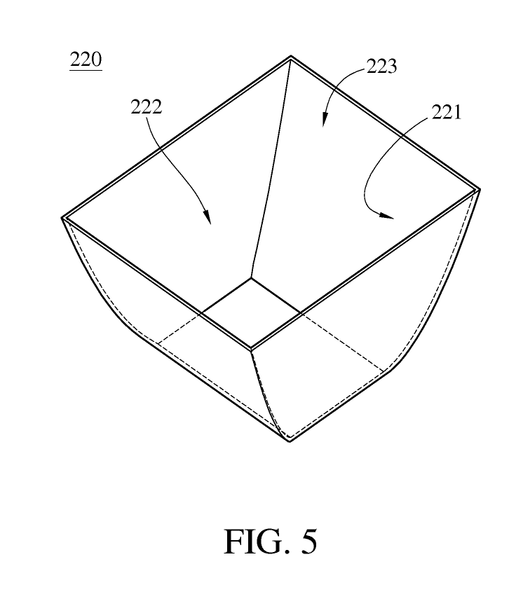

Please refer to FIG. 3 through FIG. 5. FIG. 3 is a cross-sectional view of an illumination device in FIG. 1. FIG. 4 is a partially enlarged view in FIG. 3. FIG. 5 is a perspective view of a reflective cup in FIG. 3. The illumination device 200 comprises a light source 210 and a reflective cup 220. The light source 210, for example, is an infrared light-emitting diode or a visible light-emitting diode. In this embodiment, a pattern of the intensity distribution diagram of the light source 210 (as shown in FIG. 2) is a Lambertian-type pattern. In other words, the beam which has a maximum light intensity passes along an optical axis L (as shown in FIG. 3) of the light source 210. The light intensities of beams are decreased gradually along a direction away from the optical axis L. For conciseness, only a first beam L1 and a second beam L2 emitted by the light source 210 are shown to represent all beams emitted from the light source 210. Moreover, an included angle between the first beam L1 and the optical axis L is less than an included angle between the second beam L2 and the optical axis L. A light intensity of the first beam L1 is greater than a light intensity of the second beam L2

The reflective cup 220 has a plurality of reflecting curved surfaces 221, a through hole 222 formed by the reflecting curved surfaces 221, and an opening 223 corresponding to the through hole 222. The opening 223 and transverse sections of the through hole 222 are both rectangular. The light source 210 is located at the through hole 222 and surrounded by the reflecting curved surfaces 221 of the reflective cup 220. In this embodiment, the reflecting curved surfaces 221 are formed according to an iterative method and satisfy the following conditions:

$$\begin{matrix}x = \frac{{m}_{2} {x}_{B}^{( 0 )} - {y}_{B}^{( 0 )} - {m}_{1} {x}_{A} + {y}_{A}}{{m}_{2} - {m}_{1}} = {x}_{B}^{( 1 )} & ( 1 ) \\ y = {m}_{2} ( \frac{{m}_{2} {x}_{B}^{( 0 )} - {y}_{B}^{( 0 )} - {m}_{1} {x}_{A} + {y}_{A}}{{m}_{2} - {m}_{1}} - {x}_{B}^{( 0 )} ) + {y}_{B}^{( 0 )} = {y}_{B}^{( 1 )} & ( 2 ) \\ {m}_{1} = tan ( {θ}_{1} ) & ( 3 ) \\ {m}_{2} = tan ( 90 ° - γ ) = tan ( 90 ° - \frac{{θ}_{p} - {θ}_{1}}{2} ) & ( 4 )\end{matrix}$$

wherein x_{A} and y_{A} are coordinate values of a central point (point A) of the light source 210, x_{B}⁽⁰⁾ and y_{B}⁽⁰⁾ are coordinate values of a first iteration point (point B0) of the reflecting curved surface 221, x_{B}⁽¹⁾ and y_{B}⁽¹⁾ are coordinate values of a second iteration point (point B1) of the reflecting curved surface 221, θ₁ is an included angle between the first beam L1 or the second beam L2 and X-axis, θₚ is an included angle which is closer to the light source 210 and formed between the reflected first beam or the reflected second beam and X-axis, m₁ is the slope of the first beam L1 or the second beam L2, and m₂ is the slope of the tangent line t of each point of the reflecting curved surface 221.

The formation of the reflecting curved surfaces 221 according to the iterative method is described as follows. As shown in FIG. 3 and FIG. 4, the central point A of the light source 210 is assumed as an original point of the X-Y coordinate. Each coordinate value of the reflecting curved surfaces 22 is iterated by the iterative method according to an expected beam pattern (which is a batwing-type pattern as shown in FIG. 7) of the intensity distribution diagram. When the demand for the light intensity of a region near the optical axis L is less, a beam (such as a beam with an emitting angle θ₁) with lower light intensity is reflected (such as a beam with an angle θ₂ formed between the beam and the optical axis L) to the region near the optical axis L. When the demand of the light intensity of the region near the optical axis L is greater, a beam (such as a beam with an emitting angle θ₃) with greater light intensity is reflected (such as a beam with an angle θ₄ (20 degrees) formed between the beam and the optical axis L) to a region farther away from the optical axis L. The first iteration point B0 (x_{B0}, y_{B0}) is known since the first iteration point B0 is determined according to the width of the reflective cup 220. Additionally, the second iteration point can be determined by applying the first iteration point B0 (x_{B0}, y_{B0}), x_{A}=0, y_{A}=0, m₁=tan θ₁, m₂=tan θ₅, and θ₅=90°−[(90°−θ₂+θ₁)/2−θ₁] to the conditions (1) and (2). Then, a third iteration point B2 can be determined by applying the second iteration point (point B1), x_{A}=0, y_{A}=0, m₁=tan θ₃, m₂=tan θ₆, and θ₆=90°−[(90°−θ₄+θ₂)/2−θ₂] to the conditions (1) and (2). Furthermore, all points of the reflecting curved surfaces 221 can be determined by repeating the above steps.

To be noticed, the shapes of the reflecting curved surfaces 221 are determined according to the beam pattern of the light source 210. In other words, the slope of each reflective section of each reflecting curved surface 221 is not constant. For example, the slopes of each reflective section of each reflecting curved surface 221 are increased gradually along a direction away from the light source 210 in this embodiment.

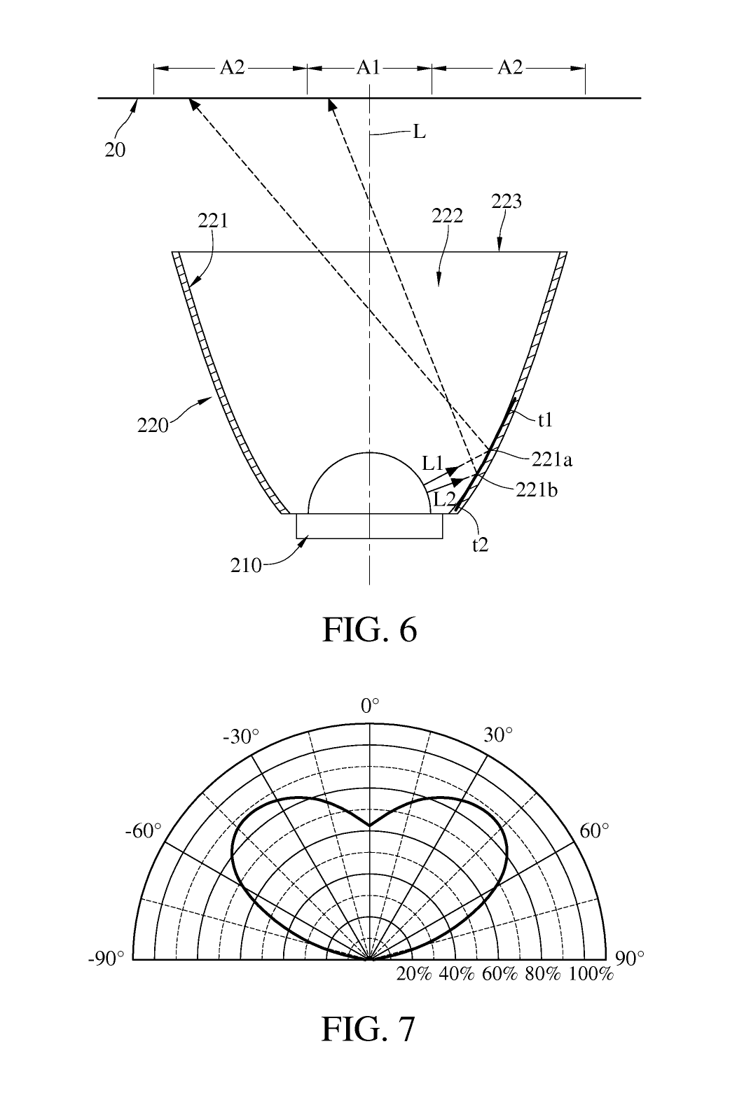

Please refer to FIG. 6 and FIG. 7. FIG. 6 is a cross-sectional view of the illumination device in FIG. 1 and an illuminated surface illuminated by the illumination device according to the first embodiment of the disclosure. FIG. 7 is an intensity distribution diagram of the light source after being reflected by the light source in FIG. 1. As shown in FIG. 6, an illuminated surface 20 illuminated by the illumination device 200 is a plane. The optical axis L of the light source 210 passes through the illuminated surface 20. The illuminated surface 20 is divided into a paraxial region A1 and an off-axis region A2 according to the distance between each point of the illuminated surface 20 to the optical axis L. The paraxial region A1 is relatively closer to the optical axis L than the off-axis region A2. Furthermore, the distance between the light source 210 to each point in the paraxial region A1 is less than the distance between the light source 210 to each point in the off-axis region A2.

According to the iterative method, each reflecting curved surface 221 has reflective sections with different slopes. For conciseness, only two reflective sections are shown to represent all reflective sections. Each reflecting curved surface 221 has a first reflective section 221a and a second reflective section 221b. A slope of the first reflective section 221a (equal to a slope of a tangent line t1) is different from a slope of the second reflective section 221b (equal to a slope of a tangent line t2). The first beam L1 with a higher light intensity is reflected to the off-axis region A2 which is farther away from the optical axis L of the light source 210 by the first reflective section 221a. The second beam L2 with a lower light intensity is reflected to the paraxial region A1 which is closer to the optical axis L of the light source 210 by the second reflective section 221b. Hence, a light intensity in the off-axis region A2 is greater than a light intensity in the paraxial region A1. That is to say, the beam pattern of the intensity distribution diagram of the light source 210 becomes the batwing type pattern (as shown in FIG. 7) from the Lambertian-type pattern (as shown in FIG. 2) due to the reflection on the reflecting curved surfaces 221 of the reflective cup 220.

Specifically, the reflective cup 220 causes the light intensity of the paraxial region A1 to be less than the light intensity of the off-axis region A2. For example, reflected by the reflective cup 220, a third beam is formed in the paraxial region A1, and a fourth beam is formed in the off-axis region A2. The third beam and the optical axis L are coaxial. A light intensity of the third beam is shown at 0 degree in FIG. 7 (about 60%). An included angle is formed between the optical axis L and the fourth beam. A light intensity of the fourth beam is shown between 0 degrees to ±90 degrees in FIG. 7 (about 0% to 90%). A ratio of the light intensity of the fourth beam to the light intensity of the third beam is 1/cos³θ (A is the included angle formed between the optical axis and the fourth beam). Furthermore, a ratio of a distance from the illuminated surface 20 in the off-axis region A2 to the light source 210 to a distance from the illuminated surface 20 in the paraxial region A1 to the light source 210 is about 1/cos³θ. Accordingly, the off-axis region A2 (which should be illuminated by beams with higher light intensities) is illuminated by beams with higher light intensities, and the paraxial region A1 (which should be illuminated by beams with lower light intensities) is illuminated by beams with lower light intensities. Thus, the illuminance of the illuminated surface 20 illuminated by the light source 210 is homogeneous throughout the whole of the illuminated surface 20.

Moreover, the opening 223 and transverse sections of the through hole 222 of the reflective cup 220 are both rectangular, and the reflecting curved surfaces 221 are capable of changing emission directions of the beams emitted form the light source 210, such that an illuminated region on the illuminated surface 20 is also rectangular. The shape of an image plane of a photosensitive element is also rectangular, such that the shape of the illuminated region corresponds to the shape of the image plane of the photosensitive element, thereby avoiding uneven exposure of the image.

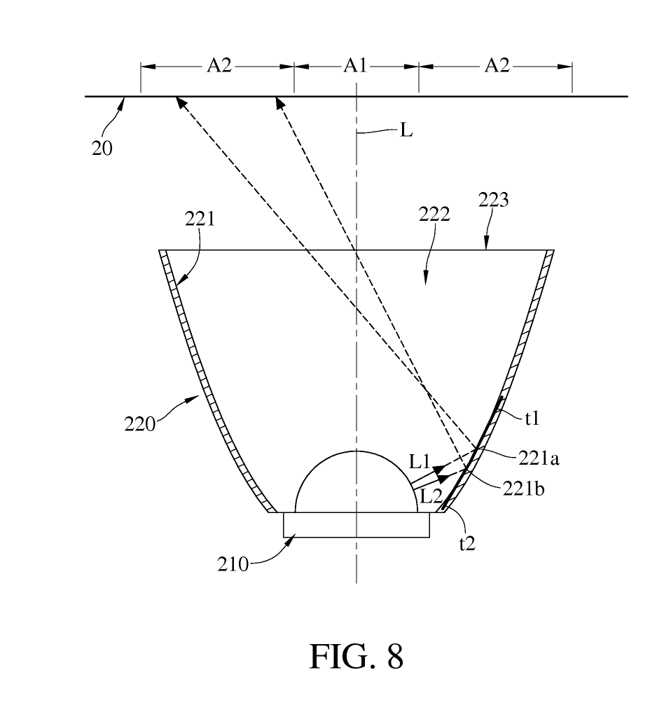

The reflecting curved surfaces 221 of the reflective cup 220 is formed according to the intensity distribution diagram of the light source 210, for reflecting some beams to the paraxial region A1 and for reflecting some beams to the off-axis region A2. Additionally, a beam pattern of the intensity distribution diagram of the light source 210 formed on the illuminated surface 20 is a batwing-type pattern. However, the beam pattern of the intensity distribution diagram is not limited to the batwing type pattern. Please refer to FIG. 8, which is a cross-sectional view of an illumination device and an illuminated surface illuminated by the illumination device according to a second embodiment of the disclosure.

In this embodiment, the reflecting curved surfaces 221 of the reflective cup 220 are also formed according to reflecting curved surface 221. Different from the first embodiment, the distribution of the light intensities of the light source 210 is mostly concentrated in the paraxial region A1 of the illuminated surface 20. Thus, the light intensities between the paraxial region A1 and off-axis region A2 are different. Accordingly, to form the batwing-type pattern on the illuminated surface 20, all beams emitted from the light source 210 have to be reflected to the off-axis region A2 of the illuminated surface 20 by the reflecting curved surfaces 221, such that the illuminance of the illuminated surface 20 illuminated by the light source 210 is homogeneous throughout the whole of the illuminated surface 20.

For example, as shown in FIG. 8, the paraxial region A1 of the illuminated surface 20 is illuminated directly (without being reflected) by the beams emitted from the light source 210, and the first beam L1 and the second beam L2 are reflected to the off-axis region A2 of the illuminated surface 20 by the reflecting curved surfaces 221, such that the illuminance of the illuminated surface 20 illuminated by the light source 210 is homogeneous throughout the whole of the illuminated surface 20.

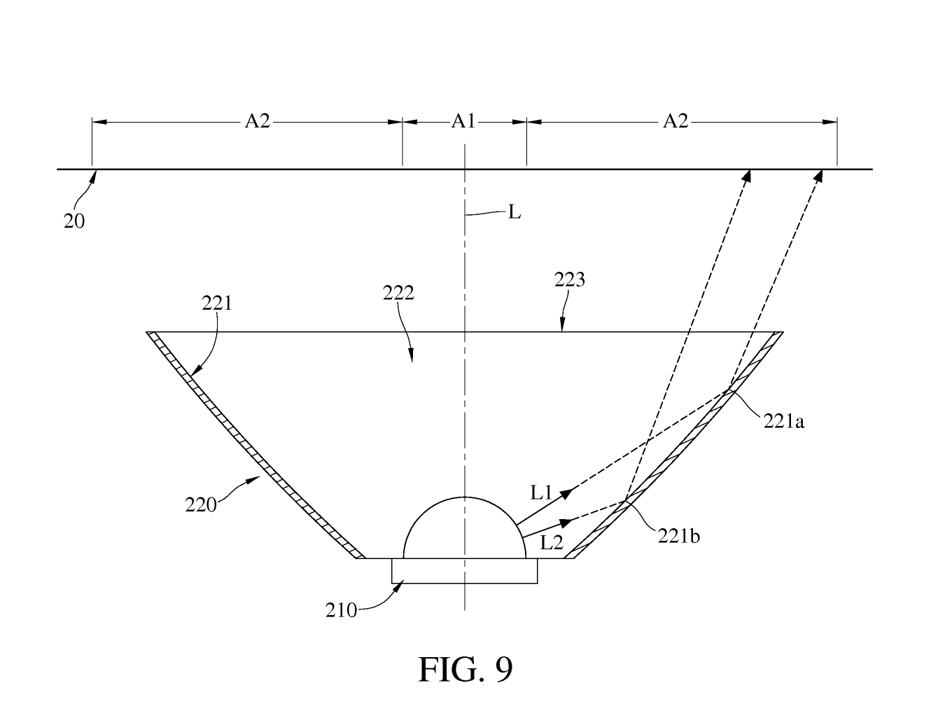

Please refer to FIG. 8 and FIG. 9. FIG. 9 is a cross-sectional view of an illumination device and an illuminated surface illuminated by the illumination device according to a third embodiment of the disclosure. This embodiment is similar to the second embodiment in FIG. 8, and the difference between two embodiments will be described as follows. The difference between this embodiment and the second embodiment in FIG. 8 is that the slopes of the reflecting curved surfaces 221 of the reflective cup 220 are increased. Thus, the beams emitted from the light source 210 are reflected reversely to the off-axis region A2 (located at a side which is opposite to a side of the reflecting curved surfaces 221 relative to the optical axis L). As shown in FIG. 8, the first beam L1 and the second beam L2 are reflected reversely to the off-axis region A2 by a first reflective section 221a and a second reflective section 221b. In contrast to the second embodiment, the slopes of the reflecting curved surfaces 221 of the reflective cup 220 are decreased. Thus, the beams emitted from the light source 210 are reflected toward the off-axis region A2 (located at a same side of the reflecting curved surfaces 221 relative to the optical axis L, as shown in FIG. 9). The reflection directions in two embodiments are different, but the principle and formula of the reflection are the same, so it will not be repeated again.

According to the illumination device and the illumination device of the disclosure, some beams emitted from the light source are reflected by the reflecting curved surfaces, such that the beam pattern of the light intensity on the illuminated surface is the batwing-type pattern, and the illuminance of the illuminated surface illuminated by the light source is homogeneous throughout the whole of the illuminated area.

Additionally, the opening and the transverse sections of the through hole of the reflective cup match with the shape of the image plane of the photosensitive element, for avoiding uneven exposure of the image.

Furthermore, the distribution of the light intensity is adjusted by reflecting the beams emitted from the light source without a lens. Accordingly, the manufacturing cost of the photographic device or the illumination device is reduced.

The disclosure will become more fully understood from the said embodiments for illustration only and thus does not limit the disclosure. Any modifications within the spirit and category of the disclosure fall in the scope of the disclosure.

What is claimed is:

1. An illumination device, comprising:
a light source having an optical axis and for emitting a first beam and a second beam, an included angle between the first beam and the optical axis being different from an included angle between the second beam and the optical axis, and a light intensity of the first beam being greater than a light intensity of the second beam; and
a reflective cup having a plurality of reflecting curved surfaces and a through hole formed by the plurality of reflecting curved surfaces, the light source being located at the through hole, the light source being surrounded by the plurality of reflecting curved surfaces, each reflecting curved surface having a first reflective section and a second reflective section, a slope of the first reflective section being different from a slope of the second reflective section, the first beam being reflected to an off-axis region which is farther away from the optical axis by the first reflective section, and the second beam being reflected to a paraxial region which is closer to the optical axis of the light source by the second reflective section, such that a light intensity in the off-axis region is greater than a light intensity in the paraxial region.

2. The illumination device according to claim 1, wherein each reflecting curved surface has a plurality of reflective sections, and slopes of the plurality of reflective sections are increased gradually along a direction away from the light source.

3. The illumination device according to claim 1, wherein the plurality of reflecting curved surfaces are formed according to an iterative method and satisfy the following conditions:
$$\begin{matrix}x = \frac{{m}_{2} {x}_{B}^{( 0 )} - {y}_{B}^{( 0 )} - {m}_{1} {x}_{A} + {y}_{A}}{{m}_{2} - {m}_{1}} = {x}_{B}^{( 1 )} & ( 1 ) \\ y = {m}_{2} ( \frac{{m}_{2} {x}_{B}^{( 0 )} - {y}_{B}^{( 0 )} - {m}_{1} {x}_{A} + {y}_{A}}{{m}_{2} - {m}_{1}} - {x}_{B}^{( 0 )} ) + {y}_{B}^{( 0 )} = {y}_{B}^{( 1 )} & ( 2 )\end{matrix}$$
wherein x_{A} and y_{A} are coordinate values of the light source, x_{B}⁽⁰⁾ and y_{B}⁽⁰⁾ are coordinate values of a first point of the reflecting curved surface, x_{B}⁽¹⁾ and y_{B}⁽¹⁾ are coordinate values of a second point of the reflecting curved surface, m₁ is a slope of the first beam or the second beam, m₂ is a slope of a tangent line of each point of the reflecting curved surface.

4. The illumination device according to claim 3, wherein each slope of the plurality of the reflecting curved surfaces according to the iterative method satisfies the following conditions:
$$\begin{matrix}{m}_{1} = tan ( {θ}_{1} ) & ( 3 ) \\ {m}_{2} = tan ( 90 ° - γ ) = tan ( 90 ° - \frac{{θ}_{p} - {θ}_{1}}{2} ) & ( 4 )\end{matrix}$$
wherein θ₁ is an included angle between the first beam or the second beam and X-axis, θₚ is an included angle which is closer to the light source and formed between the reflected first beam or the reflected second beam and X-axis, m₁ is the slope of the first beam or the second beam, m₂ is the slope of the tangent line of each point of the reflecting curved surface.

5. The illumination device according to claim 1, wherein a third beam is formed in the paraxial region, a fourth beam is formed in the off-axis region, the third beam and the optical axis are coaxial, an included angle is formed between the optical axis and the fourth beam, a ratio of a light intensity of the fourth beam to a light intensity of the third beam is 1/cos³θ, wherein θ is the included angle formed between the optical axis and the fourth beam.

6. The illumination device according to claim 1, wherein the reflective cup has an opening corresponding to the through hole, and the opening and transverse sections of the through hole are both rectangular.

7. The illumination device according to claim 1, further comprising an illuminated surface corresponding to the light source, the optical axis of the light source passing through the illuminated surface, and a distance from the illuminated surface in the paraxial region to the light source being less than a distance from the illuminated surface in the off-axis region to the light source.

8. The illumination device according to claim 7, wherein the illuminated surface is a plane.

9. An illumination device, comprising:
a light source having an optical axis and for emitting a first beam and a second beam, an included angle between the first beam and the optical axis being different from the included angle between the second beam and the optical axis, and a light intensity of the first beam being greater than a light intensity of the second beam; and
a reflective cup having a plurality of reflecting curved surfaces and a through hole formed by the plurality of reflecting curved surfaces, the light source being located at the through hole, the light source being surrounded by the plurality of reflecting curved surfaces, each reflecting curved surface having a first reflective section and a second reflective section, a slope of the first reflective section being different from a slope of the second reflective section, the first beam being reflected to an off-axis region which is farther away from the optical axis by the first reflective section, and the second beam being also reflected to the off-axis region by the second reflective section, such that a light intensity in the off-axis region is greater than a light intensity in a paraxial region which is closer to the optical axis of the light source.

10. The illumination device according to claim 9, wherein each reflecting curved surface has a plurality of reflective sections, and slopes of the plurality of reflective sections are increased gradually along a direction away from the light source.

11. The illumination device according to claim 9, wherein the plurality of the reflecting curved surfaces are formed according to an iterative method and satisfy the following conditions:
$$\begin{matrix}x = \frac{{m}_{2} {x}_{B}^{( 0 )} - {y}_{B}^{( 0 )} - {m}_{1} {x}_{A} + {y}_{A}}{{m}_{2} - {m}_{1}} = {x}_{B}^{( 1 )} & ( 1 ) \\ y = {m}_{2} ( \frac{{m}_{2} {x}_{B}^{( 0 )} - {y}_{B}^{( 0 )} - {m}_{1} {x}_{A} + {y}_{A}}{{m}_{2} - {m}_{1}} - {x}_{B}^{( 0 )} ) + {y}_{B}^{( 0 )} = {y}_{B}^{( 1 )} & ( 2 )\end{matrix}$$
wherein x_{A} and y_{A} are coordinate values of the light source, x_{B}⁽⁰⁾ and y_{B}⁽⁰⁾ are coordinate values of a first point of the reflecting curved surface, x_{B}⁽¹⁾ and y_{B}⁽¹⁾ are coordinate values of a second point of the reflecting curved surface, m₁ is a slope of the first beam or the second beam, m₂ is a slope of a tangent line of each point of the reflecting curved surface.

12. The illumination device according to claim 11, wherein each slope of the plurality of the reflecting curved surfaces according to the iterative method satisfies the following conditions:
$$\begin{matrix}{m}_{1} = tan ( {θ}_{1} ) & ( 3 ) \\ {m}_{2} = tan ( 90 ° - γ ) = tan ( 90 ° - \frac{{θ}_{p} - {θ}_{1}}{2} ) & ( 4 )\end{matrix}$$
wherein θ₁ is an included angle between the first beam or the second beam and X-axis, θₚ is an included angle which is closer to the light source and formed between the reflected first beam or the reflected second beam and X-axis, m₁ is the slope of the first beam or the second beam, m₂ is the slope of the tangent line of each point of the reflecting curved surface.

13. The illumination device according to claim 9, wherein a third beam is formed in the paraxial region, a fourth beam is formed in the off-axis region, the third beam and the optical axis are coaxial, an included angle is formed between the optical axis and the fourth beam, a ratio of a light intensity of the fourth beam to a light intensity of the third beam is 1/cos³θ, wherein θ is the included angle formed between the optical axis and the fourth beam.

14. A photographic device, comprising:
an illumination device according to claim 1, the illumination device having an illuminated surface corresponding to the light source, the optical axis passing through the illuminated surface, and the paraxial region and the off-axis region being formed on the illuminated surface; and
an image capturing device located near the illumination device for capturing images formed on the illuminated surface.

15. The photographic device according to claim 14, wherein each reflecting curved surface has a plurality of reflective sections, and slopes of the plurality of reflective sections are increased gradually along a direction away from the light source.

16. The photographic device according to claim 14, wherein the plurality of reflecting curved surfaces are formed according to an iterative method and satisfy the following conditions:
$$\begin{matrix}x = \frac{{m}_{2} {x}_{B}^{( 0 )} - {y}_{B}^{( 0 )} - {m}_{1} {x}_{A} + {y}_{A}}{{m}_{2} - {m}_{1}} = {x}_{B}^{( 1 )} & ( 1 ) \\ y = {m}_{2} ( \frac{{m}_{2} {x}_{B}^{( 0 )} - {y}_{B}^{( 0 )} - {m}_{1} {x}_{A} + {y}_{A}}{{m}_{2} - {m}_{1}} - {x}_{B}^{( 0 )} ) + {y}_{B}^{( 0 )} = {y}_{B}^{( 1 )} & ( 2 )\end{matrix}$$
wherein x_{A} and y_{A} are coordinate values of the light source, x_{B}⁽⁰⁾ and y_{B}⁽⁰⁾ are coordinate values of a first point of the reflecting curved surface, x_{B}⁽¹⁾ and y_{B}⁽¹⁾ are coordinate values of a second point of the reflecting curved surface, m₁ is a slope of the first beam or the second beam, m₂ is a slope of a tangent line of each point of the reflecting curved surface.

17. The photographic device according to claim 16, wherein each slope of the plurality of the reflecting curved surfaces according to the iterative method satisfies the following conditions:
$$\begin{matrix}{m}_{1} = tan ( {θ}_{1} ) & ( 3 ) \\ {m}_{2} = tan ( 90 ° - γ ) = tan ( 90 ° - \frac{{θ}_{p} - {θ}_{1}}{2} ) & ( 4 )\end{matrix}$$
wherein θ₁ is an included angle between the first beam or the second beam and X-axis, θₚ is an included angle which is closer to the light source and formed between the reflected first beam or the reflected second beam and X-axis, m₁ is the slope of the first beam or the second beam, m₂ is the slope of the tangent line of each point of the reflecting curved surface.

18. The photographic device according to claim 14, wherein a third beam is formed in the paraxial region, a fourth beam is formed in the off-axis region, the third beam and the optical axis are coaxial, an included angle is formed between the optical axis and the fourth beam, a ratio of a light intensity of the fourth beam to a light intensity of the third beam is 1/cos³θ, wherein θ is the included angle formed between the optical axis and the fourth beam.

19. The photographic device according to claim 14, wherein the reflective cup has an opening corresponding to the through hole, and the opening and transverse sections of the through hole are both rectangular.

20. The photographic device according to claim 14, further comprising an illuminated surface corresponding to the light source, the optical axis of the light source passing through the illuminated surface, and a distance from the illuminated surface in the paraxial region to the light source being less than a distance from the illuminated surface in the off-axis region to the light source.
